(19) United States
(12) Patent Application Publication
(10) Pub. No.: US 2004/0064366 A1
(43) Pub. Date: Apr. 1, 2004

(54) System, method and apparatus for increasing transaction conversion rate

(76) Inventor: Takao Asayama, Mountain View, CA (US)

Correspondence Address: Brull, Piccionelli, Sarno, Braun & Vradenburgh, Suite 2350, 1925 Century Park East, Los Angeles, CA, 90067, US

(21) Appl. No.: 10/607,386

(22) Filed: Jun. 26, 2003

Related U.S. Application Data
(60) Provisional application No. 60/392,660, filed on Jun. 28, 2002.

(51) Int. Cl. G06F 17/60

(52) U.S. Cl. 705/14

(57) ABSTRACT

Embodiments of the present invention are directed to a system, method and apparatus for increasing transaction conversion rates for the purchase of goods or services. Embodiments of the transaction conversion system comprise an incentive apparatus, a membership database and a notification means, wherein the incentive apparatus comprises a database, an incentive selection means and a presentation means. The database contains a list of awards and a list of sources from which the set of indicia, or winning indicia can be found. The transaction conversion system presents an award to the user computer and the conditions for winning the award, wherein to be eligible to win, the user must complete a purchase transaction. The conditions for winning set forth by the incentive selection means requires the matching of the set of indicia to information located in the pre-identified source of information.

### RELATED APPLICATION

This application claims priority from provisional patent application entitled, System, Method And Apparatus For Increasing Transaction Conversion Rate, Serial No. 60,392,660 to Takao Asayama, filed on Jun. 28, 2002, which is fully incorporated herein by reference.

### FIELD OF THE INVENTION

This invention is directed to a system, method and apparatus for increasing transaction conversion rates for the purchase of goods or services. In particular, a transaction conversion system that offers an opportunity for acquiring a reward if the transaction is completed and provides immediate verification as to whether the reward was obtained.

### BACKGROUND OF THE INVENTION

Shopping on wide area networks, such as the Internet, or World Wide Web (“WWW”) has become a common occurrence. Typically, a user enters a merchant's online web site for products or services for which they have become aware from advertising or referrals. At most web sites, available items are presented in categories and list the price of the item or service. In some instances, the user can see a picture of the item.

If a user desires to purchase a particular item, the user clicks on a hyperlink of the item represented by the item's name or a picture of the item. Upon clicking on the hyperlink of the desired item, the item is placed in an online ‘shopping cart’ provided by the web site. As the user continues to peruse the web site and available items, the user can add items into the shopping cart. Further, and similar to a store, the user can remove items from the shopping cart. A list of items contained within the shopping cart is maintained so that the user can identify the items for purchase. When the user has completed shopping, the user can click on a ‘Check Out’ button. The ‘Check Out’ button transmits the user to a series of billing pages, wherein data regarding billing information must be input by the user to complete the transaction. Until the billing information is completely entered and transmitted by the user, the transaction is not complete.

Typically, to complete the transaction, the user must enter information on a series of pages. For example, in some instances a user must enter information on a shipping information page, a payment page, and a confirmation page. Each of these pages requires the user to input information pertinent to the transaction. For instance, on the shipping page, the user must enter address and telephone information, and the method for shipping the product, so that the user can receive the product. The payment page requires credit card or method of payment information, and the confirmation page requires the user to review all of the input information for accuracy, and to input any corrections. If the information is accurate, the user must submit the order, or the order is not placed.

The current process of completing a transaction is time consuming and often times, irritating. Indeed, each page must be separately submitted to the system, wherein the user cannot progress to the next page until all information is appropriately input. Thus, if a user forgets to input some information, for example, an e-mail address, the system returns the user to the page until such information is input. This process consumes vast amounts of time, and often, users, from sheer frustration, choose to terminate the transaction rather than complete the process.

Further, although thousands of transactions conclude in the above described manner, similar to shopping at a brick and mortar establishment, a high percentage of the traffic perusing the web site are users merely ‘window’ shopping. Typically, many users add merchandise to their carts only to remove those items, or to abandon the check out process and not purchase any items. Indeed, it has been determined that most purchases are not completed at the billing or ‘check out’ page. Unlike a face to face transaction, if the user simply decides not to purchase anything, there is no embarrassment in front of a clerk, or perceived inconvenience of other shoppers in the check out line, or of the store if the items need to be returned to the shelf. Thus, other than the time spent in reviewing the web site, abandonment of the purchase is costless to the user. However, such abandonments are costly to the merchant in terms of lost sales. A need in the industry exists for a manner of motivating or encouraging users to complete transactions in a non-personal environment, thereby increasing the purchase conversion rate for the merchant.

### SUMMARY OF THE DISCLOSURE

Embodiments of the present invention are directed to a system, method and apparatus for increasing transaction conversion rates for the purchase of goods or services. Embodiments of the transaction conversion system operate on a network system having a provider server and a user computer. The transaction conversion system is coupled to, and operates in conjunction with a business, program, association or organization offering goods and services on the network system, which is accessible to the user computer via a series of web pages, wherein the series of web pages represent a web site that is directed to, and contains information about the particular business. In preferred embodiments, the interface of the business and information regarding the business resides on the provider computer, wherein the provider computer provides the user computer access to the business utilizing the transaction conversion system via the interface.

The transaction conversion system comprises an incentive apparatus, a membership database and a notification means, wherein the incentive apparatus comprises a database, an incentive selection means and a presentation means. The database contains a list of awards and a list of sources from which the set of indicia, or winning indicia can be found. The award can be any item, product or service. The transaction conversion system presents an award to the user computer and the conditions for winning the award, wherein to be eligible to win, the user must complete a purchase transaction. The conditions for winning set forth by the incentive selection means requires the matching of the set of indicia to information located in the pre-identified source of information.

The membership database identifies the businesses or merchants, that is, the web sites, participating in the incentive system. The incentive selection means is coupled to the membership database such that it can identify the participating web sites. Once a user has selected an item to purchase from the merchant web site, the user is transmitted to the billing or payment pages. Upon the user entering all of the payment information and submitting the information to the provider computer, the notification means determines whether the user's information matches the preselected indicia by comparing the user's input with the conditions for winning. If the user information matches the selected indicia, the notification means transmits a message to the user indicating the win status and identifies the user's award. If the user did not win, a message is forwarded to the user indicating that the user did not win.

A feature of preferred embodiments is that users are presented with an identified award and a defined opportunity to receive the award. An advantage to this feature is that a user can be encouraged to complete a transaction, which increases sales for a merchant.

A further feature of preferred embodiments is that the identification of the award to the user can be dynamic such that the award changes periodically. An advantage to this feature is that a user may be encouraged to purchase quickly before the award changes. A further advantage to this feature is that users are encouraged to revisit the merchant to review the new possible awards being offered.

A still further feature of preferred embodiments is that the conditions for winning are posted prior to the user purchasing. An advantage to this feature is that a user can verify whether they would win if they make the purchase.

A further feature of preferred embodiments is that the identification of the conditions for winning is interactive. An advantage to this feature is that it is fun for the users such that a user may visit the merchant's web site to engage the interactive feature and thus increase the possibility of a user purchasing an item from the merchant.

The above and other advantages of embodiments of this invention will be apparent from the following more detailed description when taken in conjunction with the accompanying drawings. It is intended that the above advantages can be achieved separately by different aspects of the invention and that additional advantages of this invention will involve various combinations of the above independent advantages such that synergistic benefits may be obtained from combined techniques.

### BRIEF DESCRIPTION OF THE DRAWINGS

The detailed description of embodiments of the invention will be made with reference to the accompanying drawings, wherein like numerals designate corresponding parts in the figures.

FIG. 1 is a network system environment in accordance with a preferred embodiment of the instant invention.

FIG. 2 illustrates a transaction conversion system in accordance with a preferred embodiment of the invention.

FIG. 3 is a representation of an interactive incentive selection apparatus.

FIG. 4 is a block diagram of the operation of the transaction conversion system in accordance with a preferred embodiment of the invention.

### DETAILED DESCRIPTION OF THE PREFERRED EMBODIMENTS

Preferred embodiments of the instant invention operate on a network, such as, for example, the Internet or World Wide Web (“WWW”), or any other type of network system, including, an internet or an intranet.

Hardware Environment:

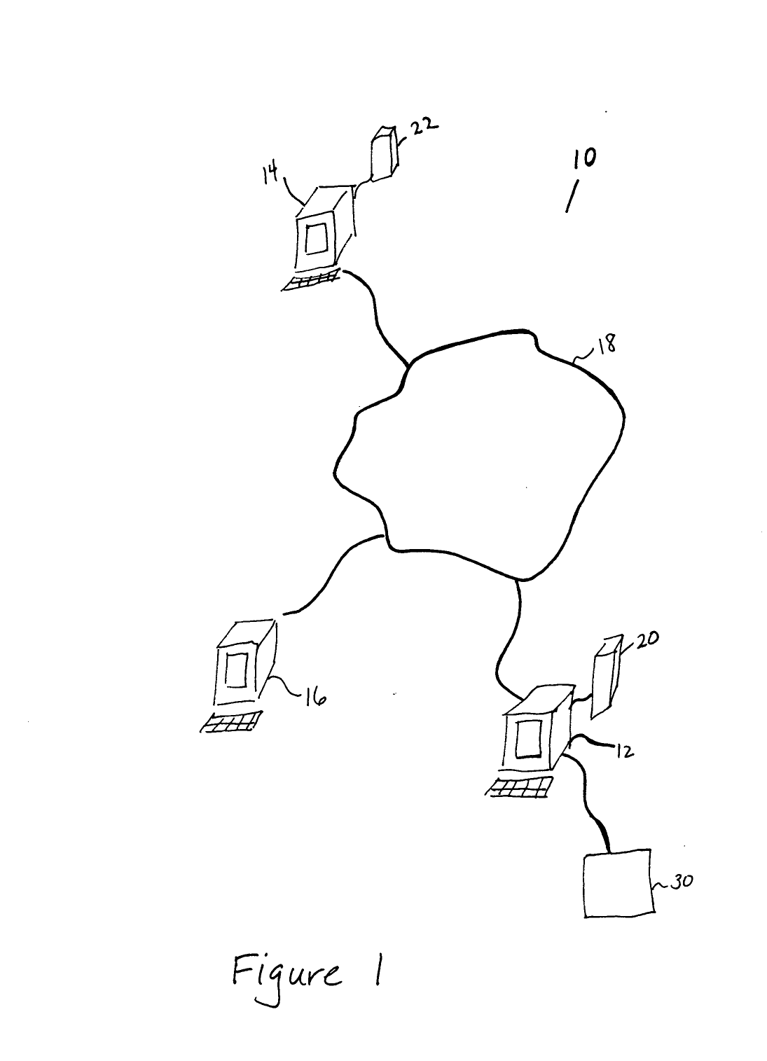

Preferred embodiments of the instant invention operate in accordance with a plurality of networked computers, such as, for example, a user computer and a provider computer which are coupled together on a communications network, such as, for example, the Internet or a wide area network. FIG. 1 depicts a network system 10 that operates in accordance with preferred embodiments of the invention. In preferred embodiments, the network system 10 includes a server computer 12, or a provider computer, a merchant computer 14, and a user computer 16, wherein the provider computer 12, the merchant computer 14 and the user computer 16 are in electronic communication with each other via a communication link 18.

In some preferred embodiments, the network system 10 includes a plurality of either the provider computer 12, the merchant computer 14, the user computer 16 or any combination thereof. The provider computer 12 and merchant computer 14 contains information regarding businesses, programs, associations or organizations offering goods and services, and other relevant data that is accessible by the user computer 16.

The provider computer 12, or server, and the merchant computer 14, may comprise any suitable network device capable of providing content (data representing text, hypertext, photographs, graphics video and/or audio) for communication over the network. In preferred embodiments, the provider computer 12 and merchant computer 14 comprises a programmable processor capable of operating in accordance with programs stored on one or more computer readable media (for example, but not limited to, floppy disks, hard disks, random access memory RAM, CD-ROM), to provide content for communication to the user computer 16. The provider computer 12 and merchant computer 14 may comprise, for example, but is not limited to, a personal computer, a mainframe computer, network computer, portable computer, personal digital assistant (such as, a 3Com Palm Pilot), or the like. The provider computer 12 and merchant computer 14 may include one or more internal data storage devices (not shown) for storing content for communication to a user computer 16. Alternatively, or in addition, the provider computer 12 and merchant computer 14 may be coupled to an external data storage device, computer or other means, generally represented at 20, 22 from which the provider computer 12 and merchant computer 14, respectively, may obtain content for communication to the user computer 16.

In a preferred wide area network environment, such as the Internet environment, the provider computer 12 and merchant computer 14 are controlled by suitable software to respond to a valid request for content by providing (or downloading) data in the form of, for example, one or more HTML files to the user computer 16 from which the request was made. It will be understood by those skilled in the art that this process involves communications through suitable servers, routers and other components, as is dictated by the particular network environment.

Each provider computer 12 and merchant computer 14 operate with a persistent storage means (not shown), for example, one or more of the fixed and/or removable data storage devices and/or data communications devices connected to the computer. The communication link 18 may include a public network, such as the Internet, a local area network, or any other suitable communications connection, hardwired, wireless, or a hybrid thereof.

The user computer 16 may comprise any suitable network device capable of communicating with other network devices in the network system. In preferred embodiments, each user computer comprises a programmable processor capable of operating in accordance with programs stored on one or more computer readable media (for example, but not limited to floppy disc, hard disc, computer network, random access memory (RAM), CD Rom, or the like), a display device 24 for providing a user-perceivable display (for example, but not limited to visual displays, such as cathode ray tube CRT displays, light-emitting-diode LED or liquid-crystal-diode LCD displays, plasma displays or the like, audio displays or tactile displays), and a user input device 26 (for example, but not limited to, a keyboard, mouse, microphone, or the like). In one preferred embodiment, at least one user computer comprises a personal computer system having a CRT display, a keyboard and a mouse user-input device.

The user computer 16 is controlled by suitable software, including network communication and browser software to allow a user to request, receive and display information (or content) from or through a provider computer 12 and a merchant computer 14 on the network system 10. The user computer 16 operates in accordance with programs stored on a readable medium, including, but not limited to, floppy disks, hard disks, RAM and CD-ROM. The user computer 16 is any means capable of communicating with the provider computer 12, or merchant computer 14 including, but not limited, to personal computers, kiosks and ATM-type machines. The user computer 16 accesses the provider computer 12 or merchant computer 14 via the wide area network or through some other remote access, such as, for example, by telephone, facsimile, personal digital assistant, web TV, or any other device or method that communicates alpha numeric data with a server.

General Description of Preferred Embodiments:

Embodiments of the present invention are directed to a system and method for increasing transaction conversion rates by encouraging or providing an incentive for a user to complete a purchase, or transaction, by completing the payment segment of the transaction. In particular, embodiments of the present invention comprise an identifiable award or incentive, which is presented to the user and may be acquired by the user if the user completes a purchase transaction. Further, embodiments of the present invention provide the user immediate and independent verification as to whether the award was obtained.

With reference again to FIG. 1, embodiments of the transaction conversion system 30 operate on a network system 10 having a provider server 12, a merchant computer 14 and a user computer 16. It is to be understood that in some preferred embodiments, a merchant computer 14 is not present. The transaction conversion system 30 resides on the provider server 12 and is coupled to, and operates in conjunction with a business, program, association or organization offering goods and services on the network system 10. In general, the business presents its goods and services on the network system 10 via an interface, such as, a series of web pages, wherein the series of web pages represent a web site that is directed to, and contains information about the particular business. In preferred embodiments, the interface of the business and information regarding the business resides on the provider computer 12, wherein the provider computer provides the user computer 16 access to the business utilizing the transaction conversion system 30 via the interface.

The transaction conversion system 30 is coupled to the business via its web sites. In this regard, the transaction conversion system 30 interfaces with the user computer 16 via the web site, or web pages, of the business. In some preferred embodiments, the interface is a pop-up advertisement or a banner advertisement that is displayed on the web site, although any other manner for interfacing with the user computer 16 via the participating merchant's business is suitable. In some preferred embodiments, and as shown in FIG. 1, a merchant computer 16 is coupled to the network system 10 via the communication link 18, and is further coupled to the transaction conversion system via the provider computer 12, wherein the merchant computer 16 includes business interfaces and information not contained on the provider computer 12. The business interfaces and information are accessible to the user computer 16 via the communication link 18. In these instances, the transaction conversion system 30 couples to the merchant computer 14, and therefore, the relevant business interfaces with the transaction conversion system via the provider computer 12.

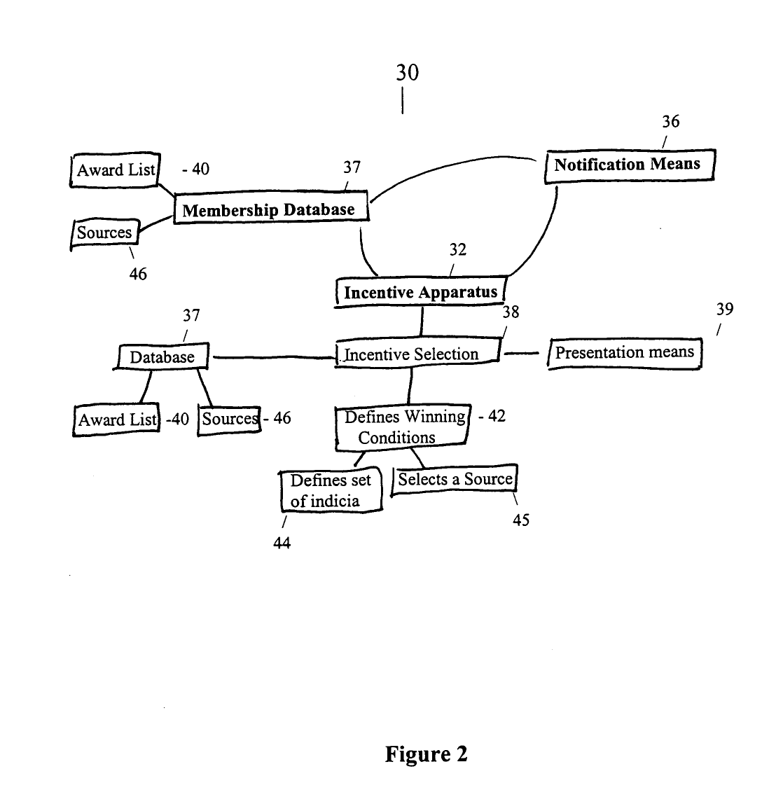

With reference to FIG. 2, the transaction conversion system 30 comprises an incentive apparatus 32, a membership database 34 and a notification means 36. The incentive apparatus 32 comprises a database 37, an incentive selection means 38 and a presentation means 39.

The database 37 contains a list of awards 40 and a list of sources 46 from which the set of indicia, or winning indicia can be found. The award can be any item, product or service. For example, in preferred embodiments, the award is a free limited time membership to a service, a free product, a gift certificate, money, discount coupon, additional products or services, or any combination thereof. In some preferred embodiments, the award group or list is defined by the transaction conversion system 30. In these embodiments, the transaction conversion system functions, for example, as a marketing agent, wherein the operator of the transaction conversion system receives compensation for operating the transaction conversion system in conjunction with business and increasing the merchant's transaction conversion rate. In some preferred embodiments, the award or group of possible awards is defined by the merchant. If the award has been defined by the merchant, it is linked or associated with the merchant in the database. Although the award is not necessarily limited by a defined value, in some embodiments, the award is selected in accordance with the value of the products or services being rendered by a merchant. In still other embodiments, the award bears no relationship, monetary or otherwise, to the products or services offered by a merchant.

At least one source is listed in the database 37. The source 46 listed in the database is an item typically possessed by a user, and is thus, a user verifiable source. Thus, the source 46 can include any item containing information that a user might possess. In preferred embodiments, the pre-identified source can include items that most users possess, such as a driver's license or a credit card, or other types of information, such as, a billing address, zip code, or a telephone number. It is to be understood that any common item typically possessed by a user is suitable, and thus, the list of sources can be easily modified.

The incentive selection means 38 is a software application that selects an award 40 and defines the conditions 42 required to achieve the award. The incentive selection means selects an award by any suitable means from the database 37, wherein the award can be systematically or randomly selected from the database 37. Once the award is selected, the incentive selection means 38 defines the conditions 42 to achieve the award by defining a set of indicia 44 and selecting a source 45 from which the defined indicia 44 must be found.

The set of indicia 44 can be a set of numbers, letters, symbols or any combination thereof, wherein the specific sequence or ordering of numbers, letters or symbol can be part of the set identification. The set of indicia 44 can be randomly generated or generated based upon external information, such as, information from a credit card database. The set of indicia 44 is not related to the provider computer 12 or the merchant.

Once the set of indicia is selected, the set of indicia is related to a source 46 from which the set of indicia must be found. In addition to selecting the source 46, the incentive selection means 38 specifies the location on the source 45 where the set of indicia must be found. For example, the set of indicia might include a set of two numbers, wherein those numbers must match the last two numbers on the user's driver's license, the first and last number of the user's street address, or any two adjacent numbers on the credit card used in the transaction. Further, combinations of indicia and sources can be used. For instance, to win, the incentive selection means selects a plurality of indicia and sources corresponding to that indicia. For example, the user must match two numbers in specified locations in the series of numbers on the payment credit card and the last character of the last name on the payment credit card. It is to be understood that the selection of numbers and/or characters that comprise the set of indicia can be randomly or systematically chosen and are unrelated to the provider computer, the web site or any business related thereto.

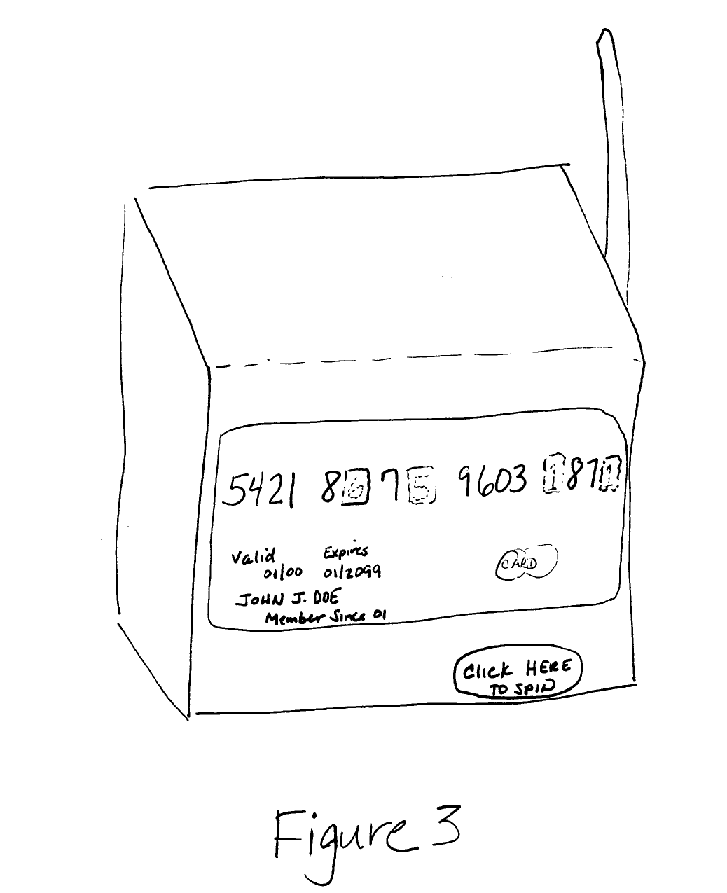

Indeed, in other preferred embodiments, the conditions to win can be presented to a user via interactive means, such as, a simulated slot machine that the user ‘plays’. For instance, with reference to FIG. 3, in one preferred embodiment, an image of a slot machine is presented to the user, wherein the slot machine has an image of a credit card across the face of the slot machine. In this embodiment, some of the numbers in the series of credit card numbers would be changeable. Upon the user clicking on the slot machine handle, the rotatable numbers on the credit card would rotate. The numbers that are randomly generated, and their position in the series of credit card numbers would represent the condition for winning. Thus, a user having a credit card with the selected numbers in the specific location would win the award upon the payment of the transaction with a credit card reflecting the winning condition. In another embodiment, all of the digits could be changeable, however, the specific digit which changed on a given ‘pull’ was random. It is to be understood that any mechanism for randomly selecting a set of predefined indicia is suitable, as is any suitable mechanism for identifying the source of information from which the predefined indicia must be found.

The presentation means 39 presents the conditions for winning to the user. Once the conditions to win are selected, the conditions for winning can be presented via a static message, a dynamically generated message, or as discussed above, via an interactive means. For example, a static message setting forth the conditions for winning include the matching of a set of preselected numbers (for example, 2439) with the third set of four digits on the credit card used to pay for the transaction. In this example, a user could review all of his credit cards to determine whether any of his credit cards meet the conditions, that is, whether any credit cards contain 2439 in the third set of digits. In other preferred embodiments, the conditions for winning can change after a predetermined amount of time and are dynamically generated. For instance, the winning combination can be maintained for a prefixed time period, such as, a day, or an hour. Thus, a user would encounter different winning combinations depending upon when the user entered the system and processed a transaction.

With reference again to FIG. 2, the membership database 34 identifies the businesses or merchants, that is, the web sites, participating in the incentive system and further, can include a listing of awards the specific merchant is willing to offer. The incentive selection means is coupled to the membership database such that it can identify the participating web sites and identify whether the award list has been defined by the merchant. If the award group has been defined by the merchant, the selection means selects an award from the merchant's approved list of awards. The membership database 34 is stored on the storage database 20 or on any other suitable memory storage that is coupled to the provider computer 12.

The notification means 36 determines whether a user has won the award. The notification means is a software application that compares user input, in particular, input corresponding to the identified source. If the input found in the pre-identified source matches the conditions for winning 42, the user is determined to have won. If the user has won the award, a winning notification is transmitted to the user computer 16. If the user did not meet the conditions for winning the award, a notification is forwarded to the user computer 16 regarding the failure to meet the conditions for winning. The notification can be forwarded to the user by any suitable means, including, but not limited to, the user's email address, home address or the user computer as a pop-up message with further instructions, if any, to obtain the award.

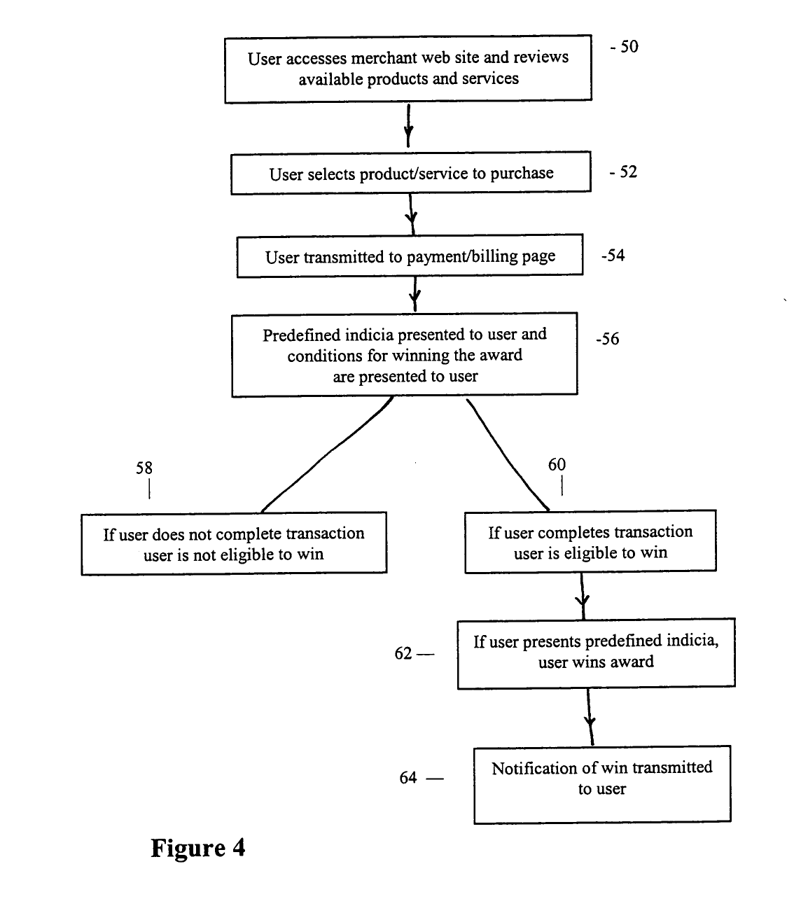

With reference to FIG. 4, in operation, a user, via the user computer, accesses the provider server 12, wherein the desired business resides. The user accesses the merchant's web site, wherein the user reviews the available products or services offered by the business 50. During the course of reviewing the available products or services, the user makes an initial determination to purchase an item 52. When the user has completed collecting the items for purchase, the user requests to complete the transaction. Upon notification to the web site, for example, by the depression of a ‘Check Out’ button, the user is transmitted to a billing page 54. In some preferred embodiments, the billing page can be a series of pages, wherein as described above, different types of information is input on each of the various pages. In some preferred embodiments, the web site offers a shopping cart wherein the user has collected a plurality of items and the ‘Check Out’ button resides on a page identifying the items in the shopping cart. In some instances, however, upon clicking on an item for purchase, the user is immediately transmitted to the check out page.

Once the user is transmitted to the check out pages, the user is presented with the award, and the conditions for winning 52, wherein to obtain, or win, the award, the user must produce a source containing data that matches the set of indicia defined by the transaction conversion system. In some preferred embodiments, to motivate users to commence the check out process, users are notified of the opportunity for receiving an award when they initially enter the web site, and can be reminded of the opportunity throughout the shopping process. For example, announcements stating ‘You May Have Already Won!’ or ‘Upon Purchase Of Any Item, You May Be A Winner!’, can be placed on the front page or throughout the shopping pages on the web site.

The conditions for winning are presented to the user in a static announcement, such as, a static message, or in any manner suitable to present the conditions for winning, including, but not limited to, a dynamic type announcement, wherein the conditions for winning the award are dynamically generated and thus, are not constant. To be eligible to win the award, the user must complete the transaction for purchasing the selected items. Thus, if the user completes the transaction, that is, the user enters all payment information, the user is eligible to win the award 58. If the information provided by the user on the payment pages matches the set of predefined indicia, the user wins the award 60. If the user fails to complete the transaction, the user is not eligible to win the award 62. Once the transaction is completed, or terminated prior to completion, the notification means determines whether the user is a winner, and transmits notification of the results to the user 64. If the user fails to complete the transaction, in some preferred embodiments, the notification means transmits a pop-up message to remind the user that he is not eligible for the award unless the transaction is completed. In other preferred embodiments, no notification is transmitted.

Although the foregoing described the invention with preferred embodiments, this is not intended to limit the invention. For example, in some preferred embodiments, the user is unaware of all the entire set of indicia required to win until the transaction process is complete. In this instance, the set of indicia to win is partially identified such that the user does not know before completing the transaction whether the user has won. For example, the user knows 3 of the 5 winning numbers and the locations on the credit card to find the winning numbers. The user can be informed of the remaining two winning numbers after the transaction has been completed. In this regard, the remaining winning indicia is identified prior to processing the user's information by the notification means, but subsequent to the user completing the transaction. Thus, the user's curiosity is peaked as he perceives an opportunity to win, and thus, participates by completing the transaction. The foregoing is intended to cover all modifications and alternative constructions falling within the spirit and scope of the invention as expressed in the appended claims, wherein no portion of the disclosure is intended, expressly or implicitly, to be dedicated to the public domain if not set forth in the claims.

What is claimed is:

1. A transaction conversion system for increasing the transaction conversion rates for a merchant on a network having a provider computer and at least one user computer, wherein the provider computer and the user computer are in communication therebetween, comprising:
an incentive apparatus;
a membership database identifying at least one merchant; and
a presentation means, wherein the presentation means is configured to present an award to the user computer for which the user is eligible to attain upon the completion of a transaction, wherein the incentive apparatus, the database and the presentation means reside on the provider computer and are coupled together.

2. A transaction conversion system as claimed in claim 1, wherein the incentive apparatus further comprises a database; an incentive selection means; and a notification means.

3. A transaction conversion system as claimed in claim 2, wherein the database stores the identification of at least one award and at least one source.

4. A transaction conversion system as claimed in claim 2, wherein the incentive selection means is a software application and is configured to select an award from the database and define the conditions for obtaining the award.

5. A transaction conversion system as claimed in claim 4, wherein defining the conditions for obtaining the award further comprise:
defining a set of winning indicia;
selecting a source from the database having at least one data location; and
corresponding a data location on the source with each of the winning indicia such that the location on the source of each member of the set of winning indicia is defined.
